(19) United States
(12) Patent Application Publication
(10) Pub. No.: US 2023/0010300 A1
(43) Pub. Date: Jan. 12, 2023

(54) TEMPERATURE DETECTION CIRCUIT AND SEMICONDUCTOR DEVICE

(71) Applicant: Rohm Co., Ltd., Kyoto (JP)

(72) Inventor: Hiroshi Yoshikawa, Kyoto (JP)

(21) Appl. No.: 17/837,353

(22) Filed: Jun. 10, 2022

(30) Foreign Application Priority Data
Jul. 7, 2021 (JP) 2021112479

(51) Int. Cl. G01K 7/01; G01K 3/00

(52) U.S. Cl. CPC G01K 7/01; G01K 3/005

(57) ABSTRACT

There is provided a technique that includes: a first voltage generation circuit configured to generate a first voltage having a positive temperature characteristic; a second voltage generation circuit that includes a first MOSFET having a gate of a first conductive type and a second MOSFET having a gate of a second conductive type different from the first conductive type, and configured to generate a second voltage having a negative temperature characteristic based on a difference in gate threshold voltages between the first MOSFET and the second MOSFET; and a comparator configured to output a temperature detection signal indicating a high/low relationship between a detection target temperature and a predetermined temperature, based on the first voltage and the second voltage.

### CROSS-REFERENCE TO RELATED APPLICATION

This application is based upon and claims the benefit of priority from Japanese Patent Application No. 2021-112479, filed on Jul. 7, 2021, the entire contents of which are incorporated herein by reference.

### TECHNICAL FIELD

The present disclosure relates to a temperature detection circuit and a semiconductor device.

### BACKGROUND

In a semiconductor device including a semiconductor integrated circuit, when an internal temperature of the semiconductor device reaches a predetermined temperature (for example, 150 degrees C.), a thermal shutdown operation for stopping an operation of the semiconductor device is often performed in order to protect the semiconductor device from heat. In order to realize the thermal shutdown operation, the semiconductor device is provided with a temperature detection circuit that detects a high/low relationship between the internal temperature of the semiconductor device and a predetermined temperature.

If a detection accuracy is low in the temperature detection circuit as described above, there is an adverse effect that it becomes difficult to design the entire semiconductor device. For example, if the maximum operating rating of the semiconductor device is set to 150 degrees C. in the specifications and the temperature detection varies by about ±25 degrees C. around 175 degrees C., it is necessary to design the temperature detection circuit so that a temperature at which the shutdown operation works is 175 degrees C. as a standard. At this time, the temperature at which the shutdown operation actually works is 150 degrees C. at the minimum and 200 degrees C. at the maximum. Then, it becomes necessary to design the semiconductor device including the temperature detection circuit so that it can operate even at 200 degrees C., which increases the difficulty of the design. Although the importance of temperature detection accuracy has been explained by focusing on the thermal shutdown operation, improving the temperature detection accuracy is beneficial in various applications.

### SUMMARY

Some embodiments of the present disclosure provide a temperature detection circuit that contributes to improving the accuracy of temperature detection, and a semiconductor device including the same.

According to one embodiment of the present disclosure, there is provided a technique that includes: a first voltage generation circuit configured to generate a first voltage having a positive temperature characteristic; a second voltage generation circuit that includes a first MOSFET having a gate of a first conductive type and a second MOSFET having a gate of a second conductive type different from the first conductive type, and configured to generate a second voltage having a negative temperature characteristic based on a difference in gate threshold voltages between the first MOSFET and the second MOSFET; and a comparator configured to output a temperature detection signal indicating a high/low relationship between a detection target temperature and a predetermined temperature, based on the first voltage and the second voltage.

According to another embodiment of the present disclosure, there is provided a technique that includes: a voltage generation circuit configured to generate a positive temperature characteristic voltage having a positive temperature characteristic; and a comparator configured to output a temperature detection signal indicating a high/low relationship between a detection target temperature and a predetermined temperature, based on the positive temperature characteristic voltage, wherein the comparator includes a first MOSFET having a gate of a first conductive type and a second MOSFET having a gate of a second conductive type different from the first conductive type, as a differential input pair, and wherein a voltage based on the positive temperature characteristic voltage is input between the gate of the first MOSFET and the gate of the second MOSFET.

### BRIEF DESCRIPTION OF DRAWINGS

FIG. 1 is an overall configuration diagram of a semiconductor device according to an embodiment of the present disclosure.

FIG. 2 is an external perspective view of the semiconductor device according to the embodiment of the present disclosure.

FIG. 3 is a diagram showing a configuration example of a functional circuit according to an embodiment of the present disclosure.

FIG. 4 is a configuration diagram of a temperature detection circuit according to a reference example.

FIG. 5 is a diagram showing characteristics of the temperature detection circuit according to the reference example.

FIG. 6 is a configuration diagram of a temperature detection circuit according to a first example belonging to the embodiment of the present disclosure.

FIG. 7 is a diagram showing an internal configuration example of a first voltage generation circuit of FIG. 6.

FIG. 8 is a diagram showing temperature dependence of a voltage generated by the first voltage generation circuit.

FIG. 9 is a diagram showing an internal configuration example of a second voltage generation circuit of FIG. 6.

FIG. 10 is a diagram showing temperature dependence of a voltage generated by the second voltage generation circuit and its divided voltage.

FIG. 11 is a diagram showing temperature dependence of two voltages compared by a comparator according to the first example belonging to the embodiment of the present disclosure.

FIG. 12 is a partial flow chart of a semiconductor device inspection process according to the first example of the embodiment of the present disclosure.

FIG. 13 is a configuration diagram of a temperature detection circuit according to a second example belonging to the embodiment of the present disclosure.

FIG. 14 is a configuration diagram of a temperature detection circuit according to a third example belonging to the embodiment of the present disclosure.

FIG. 15 is a diagram showing an internal circuit example of a comparator shown in FIG. 14.

FIG. 16 is an operation explanatory view of the comparator shown in FIG. 14.

### DETAILED DESCRIPTION

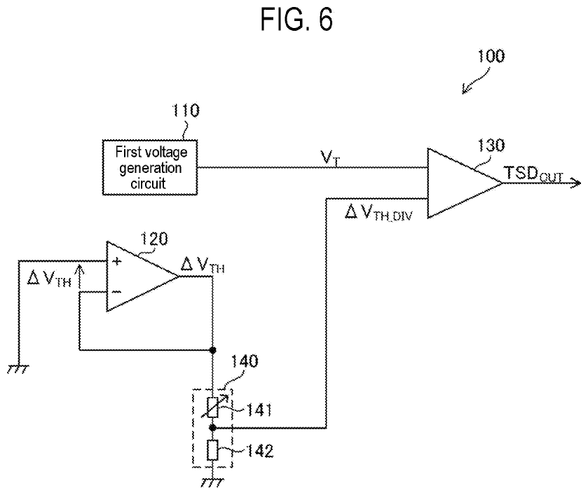

Examples of an embodiment of the present disclosure will now be described in detail with reference to the drawings. Throughout the referred drawings, the same parts are denoted by the same reference numerals, and duplicate explanation thereof will not be repeated in principle. In the present disclosure, for the sake of simplification of description, by describing a symbol or a code that refers to information, a signal, a physical quantity, an element, a part, etc., the information, the signal, the physical quantity, the element, the part, etc. corresponding to the symbol or the code may be omitted or abbreviated. For example, a first voltage generation circuit (see FIG. 6) referred to by “110” to be described later may be written as a first voltage generation circuit 110, or may be abbreviated as a voltage generation circuit 110. However, they all refer to the same thing.

First, some terms used in the description of the embodiment of the present disclosure will be described. The ground refers to a reference conductive portion having a reference potential of 0 V (zero volt) or refers to the potential of 0 V itself. The reference conductive portion is formed of a conductor such as metal. The potential of 0 V may be referred to as a ground potential. In the embodiment of the present disclosure, a voltage shown without any particular reference represents the potential seen from the ground.

Unless otherwise specified, any MOSFET shown below is regarded as an enhancement type MOSFET. MOSFET is an abbreviation for “metal-oxide-semiconductor field-effect transistor.” Unless otherwise stated, for any MOSFET shown below, it is assumed that a back gate is connected to a source. In any transistor configured as a MOSFET, a gate-source voltage refers to the potential of the gate seen from the potential of the source.

A connection between a plurality of parts forming a circuit, such as an arbitrary circuit element, wiring, and node, means an electrical connection unless otherwise specified.

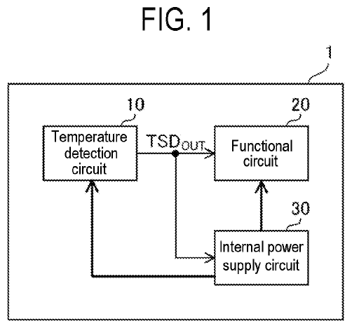

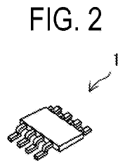

FIG. 1 shows a schematic overall configuration of a semiconductor device 1 according to an embodiment of the present disclosure. FIG. 2 is an external perspective view of the semiconductor device 1. The semiconductor device 1 is an electronic component including a semiconductor chip having a semiconductor integrated circuit formed on a semiconductor substrate, a housing (package) for accommodating the semiconductor chip, and a plurality of external terminals exposed from the housing to the outside of the semiconductor device 1. The semiconductor device 1 is formed by enclosing the semiconductor chip in the housing (package) made of resin. The number of external terminals of the semiconductor device 1 and the type of the housing of the semiconductor device 1 shown in FIG. 2 are merely examples, and they can be arbitrarily designed.

The semiconductor device 1 includes a temperature detection circuit 10, a functional circuit 20, and an internal power supply circuit 30, as circuits included in the semiconductor integrated circuit of the semiconductor device 1.

The temperature detection circuit 10 detects a high/low relationship between a detection target temperature and a predetermined determination temperature T_{TSD}, and outputs a temperature detection signal TSD_{OUT} indicating a detection result. The temperature detection signal TSD_{OUT} is a binary signal having a value of “0” or “1.” The temperature detection circuit 10 outputs the temperature detection signal TSD_{OUT} having the value of “1” when the detection target temperature is higher than the determination temperature T_{TSD}, and outputs the temperature detection signal TSD_{OUT} having the value of “0” when the detection target temperature is lower than the determination temperature T_{TSD}. Therefore, the temperature detection signal TSD_{OUT} having the value of “1” indicates that the detection target temperature is higher than the determination temperature T_{TSD}, and the temperature detection signal TSD_{OUT} having the value of “0” indicates that the detection target temperature is lower than the determination temperature T_{TSD}. The temperature detection circuit 10 outputs the temperature detection signal TSD_{OUT} having the value of “1” or “0” when the detection target temperature exactly matches the determination temperature T_{TSD}.

The functional circuit 20 is a circuit that executes a predetermined functional operation. The functional operation is an operation according to a function to be realized by the semiconductor device 1.

The internal power supply circuit 30 generates an internal power supply voltage having a predetermined DC voltage value based on a DC input voltage supplied to the semiconductor device 1 from an external power supply (not shown). The temperature detection circuit 10 and the functional circuit 20 operate based on the internal power supply voltage.

In the present embodiment, it is assumed that the temperature detection signal TSD_{OUT} is used as a thermal shutdown signal. In this case, the temperature detection circuit 10 may also be referred to as a thermal shutdown circuit, a temperature protection circuit, or the like. The temperature detection signal TSD_{OUT} as the thermal shutdown signal is input to the functional circuit 20 and the internal power supply circuit 30. The functional circuit 20 executes the above functional operation on the condition that the temperature detection signal TSD_{OUT} has the value of “0.” When the temperature detection signal TSD_{OUT} having the value of “1” is output from the temperature detection circuit 10, the functional circuit 20 stops the above functional operation in order to protect the semiconductor device 1 from excessive heat. Similarly, the internal power supply circuit 30 generates the internal power supply voltage on a condition that the temperature detection signal TSD_{OUT} has the value of “0.” When the temperature detection signal TSD_{OUT} having the value of “1” is output from the temperature detection circuit 10, the internal power supply circuit 30 stops an internal power supply voltage generation operation.

The detection target temperature is a temperature at a predetermined detection target position in the semiconductor device 1. The detection target position is preferably at or near a position on the semiconductor chip that is expected to have the highest temperature, and the temperature detection circuit 10 is preferably installed near the position on the semiconductor chip that is expected to have the highest temperature. It can be considered that the detection target position corresponds to an arrangement position of the temperature detection circuit 10. Since the temperature detection circuit 10 is provided on the semiconductor chip of the semiconductor device 1, it can be understood that the temperature of the semiconductor chip is the detection target temperature.

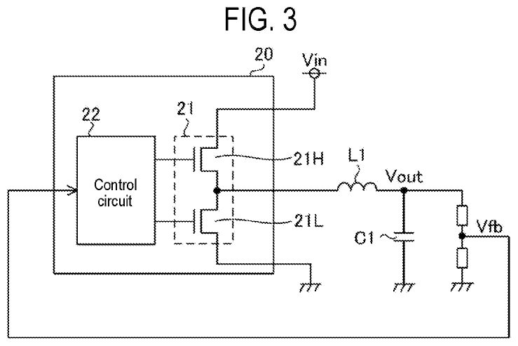

FIG. 3 shows a configuration example of the functional circuit 20 when the semiconductor device 1 is a device for forming a switching power supply device (so-called power supply IC). The switching power supply device shown in FIG. 3 is a step-down DC/DC converter that generates a predetermined output voltage Vout stabilized at a target voltage from a predetermined input voltage Vin. The input voltage Vin and the output voltage Vout have a positive DC voltage value (provided that Vin>Vout). The functional circuit 20 of FIG. 3 includes an output stage circuit 21 and a control circuit 22. The output stage circuit 21 is a half-bridge circuit which is a series circuit of a high-side transistor 21H and a low-side transistor 21L. In the configuration example of FIG. 3, the transistors 21H and 21L are configured as N-channel MOSFETs (metal-oxide-semiconductor field-effect transistors). The DC input voltage Vin is applied to the output stage circuit 21. The control circuit 22 controls gate potentials of the transistors 21H and 21L so that the transistors 21H and 21L are alternately turned on and off. As a result, a rectangular wave voltage is generated at a connection node between the transistors 21H and 21L. The output voltage Vout is obtained by rectifying and smoothing the rectangular wave voltage by a rectifying/smoothing circuit including a coil L1 and an output capacitor C1. A divided voltage of the output voltage Vout is input to the control circuit 22, as a feedback voltage Vfb. The control circuit 22 controls the state (turning-on/off state) of the transistors 21H and 21L so that the feedback voltage Vfb matches a predetermined reference voltage. As a result, the output voltage Vout is stabilized at a predetermined target voltage. In the functional circuit 20 of FIG. 3, the operation of alternately turning on/off the transistors 21H and 21L by the control circuit 22 is included in the functional operation to be executed by the functional circuit 20. When the functional operation is stopped based on the output of the temperature detection signal TSD_{OUT} having the value of “1” from the temperature detection circuit 10, both the transistors 21H and 21L are maintained in a turning-off state.

Although the functional operation when the semiconductor device 1 is a device for forming a switching power supply device (so-called power supply IC) has been described, the functional operation to be executed by the functional circuit 20 is arbitrary. That is, for example, the semiconductor device 1 may be a motor driver incorporated in a motor drive system, in which case the functional circuit 20 executes a functional operation of supplying a rectangular wave terminal voltage to each coil of a three-phase motor. Further, for example, the semiconductor device 1 may be an LED driver incorporated in a light emitting system, in which case the functional circuit 20 has a functional operation of supplying a drive current for light emission to an LED (light emitting diode) provided in the light emitting system. In either case, when the temperature detection signal TSD_{OUT} having the value of “1” is output from the temperature detection circuit 10, the above functional operation is stopped in order to protect the semiconductor device 1 from excessive heat.

In many cases, 150 degrees C. is adopted as the operating rated temperature of the semiconductor device 1. Therefore, also in the present embodiment, it is assumed that the operating rated temperature of the semiconductor device 1 is 150 degrees C., as appropriate, for embodying the description below. That is, it is assumed that the specifications of the semiconductor device 1 are defined so that the semiconductor device 1 can continue to execute the above functional operation until the detection target temperature, which is the internal temperature of the semiconductor device 1, reaches 150 degrees C. However, the operating rated temperature of the semiconductor device 1 may be other than 150 degrees C. (for example, 175 degrees C.).

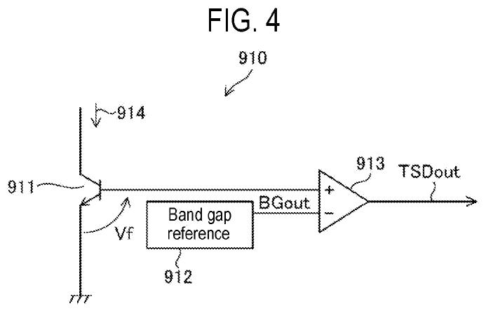

First, a reference example provided for comparison with the configuration according to the present embodiment will be described. FIG. 4 is a temperature detection circuit (thermal shutdown circuit) 910 according to the reference example. The temperature detection circuit 910 includes an NPN bipolar transistor 911, a band gap reference 912 that outputs a predetermined reference voltage BGout, and a comparator 913. The transistor 911 is diode-connected. That is, a collector and a base of the transistor 911 are short-circuited. An emitter of the transistor 911 is connected to the ground. A constant current 914 is supplied as a collector current of the transistor 911. A base-emitter voltage Vf corresponding to the constant current 914 is generated in the transistor 911 and is applied to the non-inverting input terminal of the comparator 913. The base-emitter voltage of the transistor 911 is equal to the forward voltage of a PN junction diode. The reference voltage BGout is supplied to the inverting input terminal of the comparator 913. The band gap reference 912 is a reference voltage source that uses a band gap voltage of silicon to generate the reference voltage BGout, and includes a plurality of bipolar transistors. Since the band gap reference 912 is a well-known circuit, the illustration of its internal configuration is omitted. A temperature detection signal TSDout indicating the high/low relationship between the voltages Vf and BGout is output from the comparator 913.

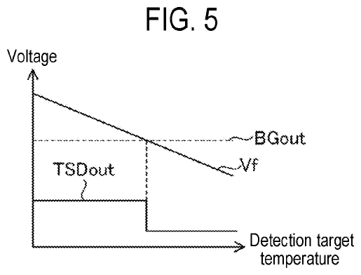

FIG. 5 shows relationships between a detection target temperature and the voltages Vf, BGout, and the temperature detection signal TSDout, with respect to the temperature detection circuit 910. The voltage Vf has a negative temperature characteristic and decreases with a constant temperature coefficient (for example, −2 mV/degrees C.) as the temperature rises. In contrast, the reference voltage BGout can be regarded as substantially invariant to the temperature change. When the high/low relationship between the voltages Vf and BGout is reversed as the temperature rises, level of the temperature detection signal TSDout changes from high level to low level. In the temperature detection circuit 910, the change of the temperature detection signal TSDout to the low level means that the detection target temperature has reached a determination temperature T_{TSD}. In a semiconductor device (not shown) including the temperature detection circuit 910, a shutdown operation is performed in response to the change.

In the configuration of FIG. 4, the level of the temperature detection signal TSDout is determined depending on the Vf characteristics of the bipolar transistor 911 alone. Therefore, the variation among individual devices is large, and a determination as to whether or not the detection target temperature has reached the determination temperature T_{TSD} fluctuates by about ±25 degrees C. at the maximum. Therefore, the temperature detection circuit 910 is designed so that a temperature at which the shutdown operation works is 175 degrees C. as a standard, at which time a temperature at which the shutdown operation actually works is 150 degrees C. at the minimum and 200 degrees C. at the maximum. Then, it becomes necessary to design the semiconductor device including the temperature detection circuit 910 so that it can operate even at 200 degrees C., which increases the difficulty of the design. Further, in order to stabilize characteristics of the voltage Vf, a current of about several μA is required as the constant current 914, and the current consumption of the band gap reference 912 is several tens of μA or more. That is, the temperature detection circuit 910 consumes a large amount of power, and it is difficult to save energy.

Hereinafter, among a plurality of examples, some specific configuration examples, operation examples, application techniques, modification techniques, and the like related to the semiconductor device 1 will be described. The above-mentioned matters regarding the semiconductor device 1 (excluding the above-mentioned matters regarding the reference example) are applied to the following examples unless otherwise specified and unless contradictory. If there is a matter inconsistent with the above-mentioned matters in each example, the description in each embodiment may take precedence. Further, unless contradictory, the matters described in any of the plurality of examples shown below may be applied to any other examples (that is, it is also possible to combine any two or more of the plurality of examples).

### First Example

A first example of the semiconductor device 1 will be described. FIG. 6 is a configuration diagram of a temperature detection circuit 100 according to the first example. The temperature detection circuit 100 can be used as the temperature detection circuit 10 of FIG. 1. The temperature detection circuit 100 includes a first voltage generation circuit 110, a second voltage generation circuit 120, a comparator 130, and a voltage divider circuit 140.

The first voltage generation circuit 110 generates and outputs a voltage V_{T} having a positive temperature characteristic. Therefore, the voltage V_{T} rises as a detection target temperature rises. The voltage V_{T} is a voltage proportional to the absolute temperature. In the present embodiment, when simply referred to as the absolute temperature, it refers to the absolute temperature of the detection target temperature (in other words, the absolute temperature of a detection target position). The absolute temperature may also be expressed as the absolute temperature T.

The second voltage generation circuit 120 is a voltage generation circuit having an amplifier configuration and generates and outputs a voltage ΔV_{TH} having a negative temperature characteristic. The value of the voltage ΔV_{TH} decreases as the detection target temperature rises.

The comparator 130 outputs the above-mentioned temperature detection signal TSD_{OUT} indicating the high/low relationship between the detection target temperature and the predetermined determination temperature T_{TSD} based on the voltages V_{T} and ΔV_{TH}. However, in the temperature detection circuit 100 according to the first example, a voltage ΔV_{TH_DIV}, which corresponds to a divided voltage of the voltage ΔV_{TH}, and the voltage V_{T} are input to the comparator 130 in which the voltage ΔV_{TH_DIV} and the voltage V_{T} are compared to each other to determine a value of the temperature detection signal TSD_{OUT}. The comparator 130 outputs the temperature detection signal TSD_{OUT} having a value of “1” when the voltage V_{T} is higher than the voltage ΔV_{TH_DIV}, and outputs the temperature detection signal TSD_{OUT} having a value of “0” when the voltage V_{T} is lower than the voltage ΔV_{TH_DIV}. As described above, the temperature detection signal TSD_{OUT} having the value of “1” indicates that the detection target temperature is higher than the determination temperature T_{TSD}, and the temperature detection signal TSD_{OUT} having the value of “0” indicates that the detection target temperature is lower than the determination temperature T_{TSD}. When the voltage V_{T} matches the voltage ΔV_{TH_DIV}, the comparator 130 outputs the temperature detection signal TSD_{OUT} having the value of “1” or “0.”

The voltage divider circuit 140 divides the voltage ΔV_{TH} output from the second voltage generation circuit 120 with a variable voltage division ratio, thereby generating the voltage ΔV_{TH_DIV}. Specifically, the voltage divider circuit 140 consists of a series circuit of resistors 141 and 142. When the output terminal of the second voltage generation circuit 120 is connected to one end of the resistor 141, the voltage ΔV_{TH} is applied to the one end of the resistor 141. The other end of the resistor 141 is connected to the ground via the resistor 142. Therefore, a voltage corresponding to a resistance value ratio between the resistors 141 and 142 and proportional to the voltage ΔV_{TH} is generated as the voltage ΔV_{TH_DIV} at a connection node between the resistors 141 and 142. Here, the resistor 141 is a variable resistor, and the resistor 142 is a fixed resistor. That is, the value of the resistor 141 is variable, and the value of the resistor 142 is fixed. By adjusting the value of the resistor 141, the voltage division ratio (that is, the ratio of the voltage ΔV_{TH_DIV} to the voltage ΔV_{TH}) when the voltage ΔV_{TH_DIV} is generated from the voltage ΔV_{TH} can be adjusted. The resistors 141 and 142 are matched so that the resistors 141 and 142 have the same temperature characteristics, and the resistance value ratio between the resistors 141 and 142 can be regarded as invariant with respect to the temperature change. Further, while the resistor 141 may be a fixed resistor, the resistor 142 may be a variable resistor, in which case the voltage division ratio can be adjusted by adjusting the value of the resistor 142. Alternatively, both the resistors 141 and 142 can be variable resistors. Here, it is assumed that, of the resistors 141 and 142, only the resistor 141 is a variable resistor.

The first voltage generation circuit 110 can be configured by a so-called PTAT circuit. PTAT is an abbreviation for “Proportional To Absolute Temperature.”

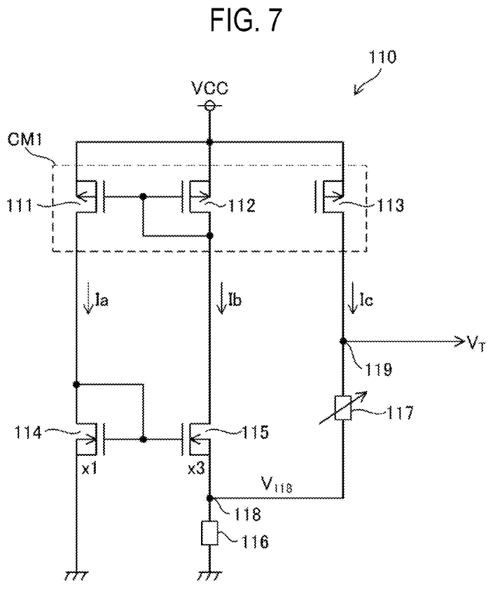

FIG. 7 shows an internal circuit example of the first voltage generation circuit 110. The first voltage generation circuit 110 of FIG. 7 includes transistors 111 to 115 and resistors 116 and 117. The resistor 117 is a variable resistor. That is, the value of the resistor 117 can be changed. A current mirror circuit CM1 is formed by the transistors 111 to 113. The transistors 111, 112, and 113 are P-channel MOSFETs. The transistors 114 and 115 are N-channel MOSFETs.

The current mirror circuit CM1 supplies a current Ia to a path including the transistor 114, supplies a current Ib to a path including the transistor 115, and supplies a current Ic to a path including the resistor 117. Here, the currents Ia, Ib, and Ic have the same current value. However, the value of the current Ic may be k_{Y} times the value of the current Ia. k_{Y} is a positive value different from 1 (for example, k_{Y}=2). In the following, it is assumed that “k_{Y}=1.”

Specifically, each source of the transistors 111, 112, and 113 is connected to the application end of an internal power supply voltage VCC (that is, a terminal to which the internal power supply voltage VCC is applied). The internal power supply voltage VCC is a predetermined positive DC voltage generated by the internal power supply circuit 30 (see FIG. 1). Gates of the transistors 111, 112, and 113 are connected in common to each other, and the gate and a drain of the transistor 112 are short-circuited. A drain of the transistor 111, a drain and the gate of the transistor 114, and the gate of the transistor 115 are connected to each other. A drain of the transistor 112 is connected to a drain of the transistor 115. A source of the transistor 114 is directly connected to the ground, while a source of the transistor 115 is connected to the ground via the resistor 116. That is, the source of the transistor 115 is connected to one end of the resistor 116 at a node 118, and the other end of the resistor 116 is connected to the ground. A drain of the transistor 113 is connected to one end of the resistor 117 at a node 119. The other end of the resistor 117 is connected to the node 118.

The transistors 111, 112, and 113 have the same structure. An area of the source of the transistor 115 is larger than an area of the source of the transistor 114. Here, it is assumed that the area of the source of the transistor 115 is three times as large as the area of the source of the transistor 114. The transistors 114 and 115 have the same structure except for a difference in the source areas. The transistor 115 may be formed by providing three transistors equivalent to the transistor 114 and connecting the three transistors in parallel.

Since a drain current of the same current value flows through the transistors 114 and 115 due to the function of the current mirror circuit CM1, a current density of the transistor 115 is ⅓ times that of a current density of the transistor 114. Based on this difference in current density, a voltage difference (V_{GS_114}−V_{GS_115}) occurs between a gate-source voltage V_{GS_114} of the transistor 114 and a gate-source voltage V_{GS_115} of the transistor 115. This voltage difference (V_{GS_114}−V_{GS_115}) is applied between both ends of the resistor 116. Accordingly, a voltage V₁₁₈ at the node 118 coincides with the voltage difference (V_{GS_114}−V_{GS_115}). The voltage V₁₁₈ at the node 118 satisfies the following equation (1).

V₁₁₈=(K_{B}·T/q)×ln(m) (1)

In the equation (1), K_{B} represents the Boltzmann constant, T represents the absolute temperature, q represents the charge of the electron, and ln(m) represents the natural logarithm of m. In the equation (1), m represents the ratio of the source area of the transistor 115 to the source area of the transistor 114. In the present example, “m=3,” but the value of m can be variously modified (however, m>1).

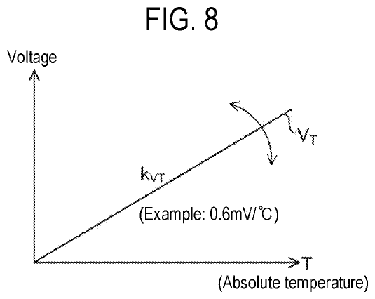

A voltage at the node 119 is output from the first voltage generation circuit 110, as the voltage V_{T}. FIG. 8 shows a relationship between the voltage V_{T} and the absolute temperature T. The voltage V_{T} is proportional to the voltage V₁₁₈ applied to the node 118, and its proportionality coefficient depends on the resistance value ratio between the resistances 116 and 117. Therefore, by adjusting the value of the resistor 117, the temperature coefficient k_{VT} of the voltage V_{T} can be adjusted. The temperature coefficient k_{VT} of the voltage V_{T} represents the amount of change in the voltage V_{T} when the absolute temperature T rises by one degree C., and is proportional to the value “(K_{B}/q)×ln(m).” The temperature coefficient k_{VT} of the voltage V_{T} is, for example, “+0.6 [mV/degrees C.].” The resistors 116 and 117 are matched so that the resistors 116 and 117 have the same temperature characteristics, and the resistance value ratio between the resistors 116 and 117 can be regarded as invariant with respect to the temperature change. Further, while the resistor 117 may be a fixed resistor, the resistor 116 may be a variable resistor, in which case the temperature coefficient k_{VT} of the voltage V_{T} can be adjusted by adjusting the value of the resistor 116. Alternatively, both the resistors 116 and 117 can be variable resistors. Here, it is assumed that, of the resistors 116 and 117, only the resistor 117 is a variable resistor.

Further, in the first voltage generation circuit 110, the transistors 114 and 115 operate in a sub-threshold region. That is, the gate-source voltage V_{GS_114} of the transistor 114 is less than a gate threshold voltage of the transistor 114, the current Ia flows between the drain and the source of the transistor 114 due to sub-threshold conduction. Further, the gate-source voltage V_{GS_115} of the transistor 115 is less than a gate threshold voltage of the transistor 115, and the current Ib flows between the drain and the source of the transistor 115 due to sub-threshold conduction. By appropriately setting the internal power supply voltage VCC and the gate length, gate width, and the like of each transistor constituting the first voltage generation circuit 110, the operation in the sub-threshold region can be realized. For example, at the room temperature (25 degrees C.), the current Ia is set to about 10 nA (nano ampere) (the same applies to the currents Ib and Ic).

The sub-threshold region is also referred to as a weak inversion region. The gate threshold voltage is a gate-source voltage at the boundary between a strong inversion region and the weak inversion region. That is, for example, for any N-channel type MOSFET of interest, when the gate potential of the MOSFET of interest is higher than a voltage obtained by adding the gate threshold voltage of the MOSFET of interest to the source potential of the MOSFET of interest, the MOSFET of interest operates in the strong inversion region, and otherwise, the MOSFET of interest operates in the weak inversion region.

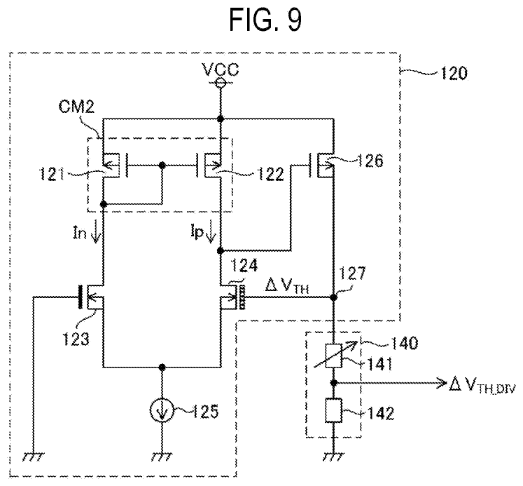

FIG. 9 shows an internal circuit example of the second voltage generation circuit 120 together with the voltage divider circuit 140. The second voltage generation circuit 120 of FIG. 9 includes transistors 121 to 124 and 126, and a constant current source 125. A current mirror circuit CM2 is formed by the transistors 121 and 122. The transistors 121 and 122 have the same structure. The transistors 121 and 122 are P-channel MOSFETs. The transistor 126 is an N-channel type MOSFET.

The transistors 123 and 124 are N-channel MOSFETs, but the conductive type of a gate of the transistor 123 and the conductive type of a gate of the transistor 124 are different from each other. Specifically, the gate of the transistor 123 is formed of n-type polysilicon (n-type semiconductor) obtained by doping polysilicon with phosphorus or arsenic. On the other hand, the gate of the transistor 124 is formed of p-type polysilicon (p-type semiconductor) obtained by doping polysilicon with boron or aluminum. The transistor 123 and the transistor 124 have the same structure except that the conductive types of the gates are different from each other. The transistors 123 and 124 are formed in the same manufacturing process except for the step of doping the gates with impurities to make this difference.

Since the conductive types of the gates of the transistors 123 and 124 are different from each other, there is a difference between the work function of the gate of the transistor 123 and the work function of the gate of the transistor 124, and by an amount corresponding to the difference, a difference is generated between a gate threshold voltage of the transistor 123 and a gate threshold voltage of the transistor 124. In the second voltage generation circuit 120, a voltage ΔV_{TH} corresponding to the difference between the gate threshold voltage of the transistor 123 and the gate threshold voltage of the transistor 124 is generated. In other words, a voltage corresponding to the difference between the work function of the gate of the transistor 123 and the work function of the gate of the transistor 124 is generated as the voltage ΔV_{TH}.

Further, the transistor 123 is configured as a depletion type MOSFET. Therefore, the gate threshold voltage of the transistor 123 has a negative voltage value. Based on a difference in conductive type of the gate, the gate threshold voltage of the transistor 124 is higher by about 1.0 V than the gate threshold voltage of the transistor 123 at the room temperature (25 degrees C.). For example, if the gate threshold voltage of the transistor 123 is −0.4 V, the gate threshold voltage of the transistor 124 is about 0.6 V. At this time, the voltage ΔV_{TH} of about 1.0 V is generated from “0.6−(−0.4)=1.0”.

The connection relationship of the elements of FIG. 9 will be described. Each source of the transistors 121 and 122 and the drain of the transistor 126 are connected to the application end of the internal power supply voltage VCC (that is, the terminal to which the internal power supply voltage VCC is applied). The gate and the drain of the transistor 121, the gate of the transistor 122, and the drain of the transistor 123 are connected in common to each other. The gate of the transistor 123 is connected to the ground. The drain of the transistor 122, the gate of the transistor 126, and the drain of the transistor 124 are connected in common to each other. The gate of the transistor 124 and the source of the transistor 126 are connected at a node 127. One end of the resistor 141 is connected to the node 127, and the other end of the resistor 141 is connected to the ground via the resistor 142. Each source of the transistors 123 and 124 is connected to one end of the constant current source 125, and the other end of the constant current source 125 is connected to the ground.

The current mirror circuit CM2 supplies a current In to a path including the transistor 123, and supplies a current Ip to a path including the transistor 124. Here, the currents In and Ip have the same current value. The current In corresponds to the drain current of the transistor 121, and the current Ip corresponds to the drain current of the transistor 122. The current In flows between the drain and the source of the transistor 123. The current Ip flows between the drain and the source of the transistor 124 (provided that the transition state in which the gate potential of the transistor 126 changes is ignored). The constant current source 125 operates so as to flow a predetermined constant current from a node to which the sources of the transistors 123 and 124 are connected, toward the ground. The constant current by the constant current source 125 is the sum of the drain current of the transistor 123 and the drain current of the transistor 124.

In the second voltage generation circuit 120 configured in this way, as described above, based on the difference between the gate threshold voltage of the transistor 123 and the gate threshold voltage of the transistor 124 (in other words, based on the difference between the work function of the gate of the transistor 123 and the work function of the gate of the transistor 124), the gate potential of the transistor 124 is higher by the voltage ΔV_{TH} than the gate potential of the transistor 123, and as a result, a voltage at the node 127 becomes the voltage ΔV_{TH}. When the voltage ΔV_{TH} at the node 127 is divided by the voltage divider circuit 140, the voltage ΔV_{TH_DIV} is generated in the connection node between the resistors 141 and 142. The value of the voltage ΔV_{TH_DIV} is determined by the ratio of the value of the voltage ΔV_{TH} and the values of the resistors 141 and 142.

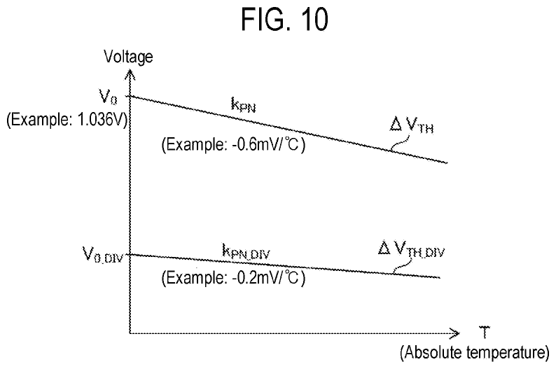

FIG. 10 shows a relationship between the voltages ΔV_{TH} and ΔV_{TH_DIV} and the absolute temperature T. The voltages ΔV_{TH} and ΔV_{TH_DIV} satisfy the following equations (2) and (3).

ΔV_{TH}=V₀+k_{PN}·T (2)

ΔV_{TH_DIV}=V_{0_DIV}+k_{PN_DIV}·T (3)

In the equations (2) and (3), T represents the absolute temperature. In the equation (2), V₀ represents the value of the voltage ΔV_{TH} when the absolute temperature T is 0 Kelvin. In the equation (3), V_{0_DIV} represents the value of the voltage ΔV_{TH}_DIV when the absolute temperature T is 0 Kelvin. In the equation (2), k_{PN} represents the temperature coefficient of the voltage ΔV_{TH}. The temperature coefficient k_{PN} of the voltage ΔV_{TH} represents the amount of change in the voltage ΔV_{TH} when the absolute temperature T rises only by one degree. In the equation (3), k_{PN_DIV} represents the temperature coefficient of voltage ΔV_{TH_DIV}. The temperature coefficient k_{PN_DIV} of the voltage ΔV_{TH_DIV} represents the amount of change in the voltage ΔV_{TH_DIV} when the absolute temperature T rises only by one degree. Here, it is assumed that the voltage V₀ is 1.036 V (volt) and the temperature coefficient k_{PN} is “−0.6 [mV/degrees C.].” Then, for example, if the ratio of the value of the resistor 141 and the value of the resistor 142 is set to “2:1,” then “ΔV_{TH_DIV}=ΔV_{TH}/3,” so that the voltage V_{0_DIV} is about 0.345 V (volt) and the temperature coefficient k_{PN_DIV} is “−0.2 [mV/degrees C.].”

Further, in the second voltage generation circuit 120, the transistors 123 and 124 operate in the sub-threshold region. That is, the gate-source voltage of the transistor 123 is less than the gate threshold voltage of the transistor 123, and the current In flows between the drain and the source of the transistor 123 due to sub-threshold conduction. Further, the gate-source voltage of the transistor 124 is less than the gate threshold voltage of the transistor 124, and the current Ip flows between the drain and the source of the transistor 124 due to sub threshold conduction. By appropriately setting the internal power supply voltage VCC and the gate length, gate width, and the like of each transistor constituting the second voltage generation circuit 120, the operation in the sub-threshold region can be realized. For example, at the room temperature (25 degrees C.), the constant current by the constant current source 125 is set to about 10 nA (nano ampere).

The magnitude of the constant current by the constant current source 125 may be the same as the magnitude of the current Ia in FIG. 7. That is, for example, the constant current source 125 may be formed in an N-channel MOSFET having a drain connected to each source of the transistors 123 and 124, a gate connected to the gate of the transistor 114 (FIG. 7), and a source connected to the ground.

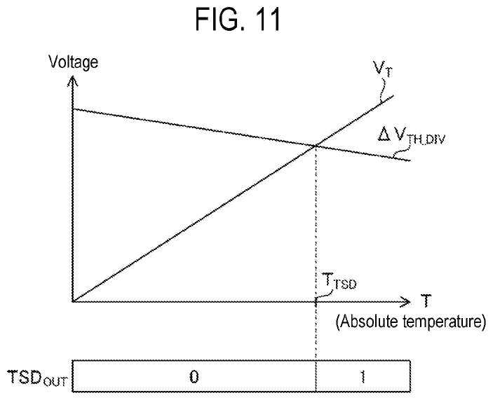

FIG. 11 shows absolute temperature dependence of the voltages V_{T} and ΔV_{TH_DIV}. FIG. 11 also shows a relationship between the absolute temperature T and the temperature detection signal TSD_{OUT}. The absolute temperature T when the voltages V_{T} and ΔV_{TH_DIV} exactly match corresponds to the above-mentioned determination temperature T_{TSD}. In a state where the absolute temperature T is 0 Kelvin, “V_{T}<ΔV_{TH_DIV}.” As the absolute temperature T rises from 0 Kelvin toward the determination temperature T_{TSD}, a difference between the voltages V_{T} and ΔV_{TH_DIV} decreases while maintaining “V_{T}<ΔV_{TH_DIV}.” When the absolute temperature T coincides with the determination temperature T_{TSD}, “V_{T}=ΔV_{TH_DIV},” and when the absolute temperature T becomes higher than the determination temperature T_{TSD}, “V_{T}>ΔV_{TH_DIV}.” As described above, the absolute temperature T refers to the absolute temperature of the detection target temperature (in other words, the absolute temperature of the detection target position). Therefore, when the detection target temperature is lower than the determination temperature T_{TSD}, the temperature detection signal TSD_{OUT} has a value of “0,” and when the detection target temperature is higher than the determination temperature T_{TSD}, the temperature detection signal TSD_{OUT} has a value of “1.” When the detection target temperature exactly coincides with the determination temperature T_{TSD}, the temperature detection signal TSD_{OUT} has a value of “0” or “1.”

The determination temperature T_{TSD} can be adjusted by adjusting the value of the resistor 141 (see FIG. 9) configured as a variable resistor, and further, the determination temperature T_{TSD} can also be adjusted by adjusting the value of the resistor 117 (see FIG. 7) configured as a variable resistor.

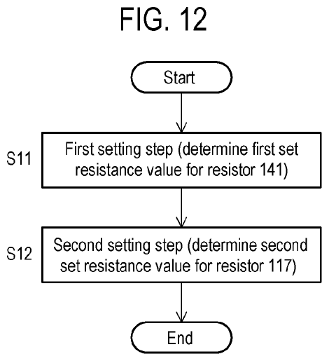

Referring to FIG. 12, an inspection process performed before the semiconductor device 1 is shipped includes a first setting step of step S11 and a second setting step of step S12. The resistor 141 is configured so that the value of the resistor 141 can be set to any one of a plurality of first candidate resistance values, and in the first setting step, any one of the plurality of first candidate resistance values is selected as the value of the resistor 141. The selected first candidate resistance value is referred to as a first set resistance value. The resistor 117 is configured so that the value of the resistor 117 can be set to any one of a plurality of second candidate resistance values, and in the second setting step, any one of the plurality of second candidate resistance values is selected as the value of the resistor 117. The selected second candidate resistance value is referred to as a second set resistance value. When the semiconductor device 1 is started after the inspection process including the first and second setting steps, the resistor 141 has the first set resistance value and the resistor 117 has the second set resistance value.

For example, in the inspection process of the semiconductor device 1, the setting data corresponding to the first set resistance value and the setting data corresponding to the second set resistance value are stored in a nonvolatile memory (not shown) provided in the semiconductor device 1. Then, when the semiconductor device 1 is started after the inspection process, the temperature detection circuit 100 reads the setting data corresponding to the first set resistance value and the setting data corresponding to the second set resistance value from the nonvolatile memory, so that the values of the resistors 141 and 117 may be set to the first and second set resistance values, respectively. Alternatively, in the inspection process of the semiconductor device 1, the values of the resistors 141 and 117 may be set to the first and second set resistance values by laser trimming (fuse cut method), respectively, and thereafter, the values of the resistors 141 and 117 may be unchanged.

In the first setting step, the first set resistance value is determined so that the determination temperature T_{TSD} approaches a desired target set temperature as close as possible (possibly matches the desired target set temperature). That is, among the plurality of first candidate resistance values, the first candidate resistance value for minimizing a difference between the determination temperature T_{TSD} and the target set temperature is selected as the first set resistance value.

The second setting step is executed on the premise that the resistor 141 has the first set resistance value. In the second setting step, the second set resistance value is determined so that the determination temperature T_{TSD} approaches a desired target set temperature as close as possible (possibly matches the desired target set temperature). That is, among the plurality of second candidate resistance values, the second candidate resistance value for minimizing a difference between the determination temperature T_{TSD} and the target set temperature is selected as the second set resistance value. For example, 1% of the optimum voltage (the voltage V_{T} when the determination temperature T_{TSD} is assumed to exactly match the target set temperature) of the voltage V_{T} is set as the adjustment unit, and the plurality of second candidate resistance values are set so that the voltage V_{T} can be changed for each adjustment unit.

The first and second setting steps are carried out in a predetermined calibration environment in which the ambient temperature of the semiconductor device 1 is about 25 degrees C. The detection target temperature at this time is considerably lower than the target set temperature and the operating rated temperature of the semiconductor device 1. In the first and second setting steps, the first and second set resistance values may be determined by calculation with certain assumptions based on the voltages V_{T} and ΔV_{TH_DIV} when the semiconductor device 1 is operated in the predetermined calibration environment.

### Comparison with Reference Example

Here, the temperature detection circuit 910 (FIG. 4) according to the reference example is compared with the temperature detection circuit 100 (FIG. 6) according to the first example.

Although partially overlapping with the above-described contents, in summary, the configuration of the reference example (FIG. 4) has the following features J_{A1} to J_{A3}.

First, the configuration of the reference example has the feature J_{A1} that the current consumption is large (as compared with the configuration of the first example). In the configuration of the reference example, it is assumed that the current consumption is several tens of μA or more.

Second, the configuration of the reference example has the feature J_{A2} that the determination of whether or not the detection target temperature has reached the determination temperature T_{TSD} fluctuates by about ±25 degrees C. at the maximum. Therefore, when the temperature detection circuit 910 is designed so that the temperature at which the shutdown operation works is 175 degrees C. as the standard, the temperature at which the shutdown operation actually works is 150 degrees C. at the minimum and 200 degrees C. at the maximum. Then, it becomes necessary to design the semiconductor device including the temperature detection circuit 910 so that it can operate even at 200 degrees C., which increases the difficulty of the design.

Third, the configuration of the reference example has the feature J_{A3} that the single bipolar element 911 is used as an element for generating a temperature-dependent voltage. In the case of using the single bipolar element, the variation in generated voltage becomes very large as compared with a case where a relative circuit (relative circuit configuration) is adopted.

On the other hand, the configuration of the first example (FIGS. 6, 7, and 9) has the following features J_{B1} to J_{B4}.

First, the configuration of the first example has the feature J_{B1} that the current consumption is small (as compared with the configuration of the reference example). By using the sub threshold region of the MOSFET for generating the voltages V_{T} and ΔV_{TH}, the total current consumption of the circuit for generating the voltages V_{T} and ΔV_{TH} can be suppressed to 1 μA or less (for example, about 250 nA), thereby achieving the high energy saving effect.

Second, the configuration of the first example has the feature J_{B2} that the variation in the determination of whether or not the detection target temperature has reached the determination temperature T_{TSD} (hereinafter may be referred to as the temperature detection variation) is within about ±20 degrees C. (which will be described later) even if the first and second setting steps shown in FIG. 12 are not performed.

Third, the configuration of the first example has the feature J_{B3} that a MOSFET separated from the semiconductor substrate (insulated from the semiconductor substrate) is used instead of the bipolar element. Therefore, as compared with the reference example, it is less susceptible to a noise from the semiconductor substrate and less susceptible to a parasitic current that may occur via the semiconductor substrate. The semiconductor device 1 (see FIG. 1) has the semiconductor substrate, and an epitaxial layer is provided on the semiconductor substrate by using epitaxial growth. All MOSFETs (especially, the transistors 123 and 124) included in the first voltage generation circuit 110, the second voltage generation circuit 120, and the comparator 130 are formed in the epitaxial layer (that is, each MOSFET is formed in the epitaxial layer).

As the fourth feature J_{B4}, in the configuration of the first example, since the relative circuit (relative circuit configuration) is adopted in each of the voltage generation circuits 110 and 120, most of the variation in characteristic of the element can be canceled. Since most of the variation in characteristics of the element can be canceled, the variation in temperature detection is within ±20 degrees C. even if the first and second setting steps are not performed. Further, it is possible to reduce the variation in temperature detection to about ±10 degrees C. by using the first and second setting steps. Then, when the temperature detection circuit 10 is designed so that the temperature at which the shutdown operation works is 160 degrees C. as a standard, the temperature at which the shutdown operation actually works is 150 degrees C. at the minimum and 170 degrees C. at the maximum. That is, it is sufficient to design the semiconductor device 1 so that it can operate up to 170 degrees C., and the ease of designing the entire circuit is dramatically improved over the semiconductor device (see FIGS. 4 and 5) according to the reference example which needs to secure the operation up to 200 degrees C.

In the second voltage generation circuit 120 of FIG. 9, the transistors 123 and 124 are relative circuits. The transistors 123 and 124 have the same structure except that the conductive type of the gate differs between the transistors 123 and 124. The transistors 121 and 122 also have the same structure. Further, in the semiconductor substrate, the transistors 123 and 124 are arranged adjacent to each other, and the transistors 121 and 122 are arranged adjacent to each other. Then, in the second voltage generation circuit 120 of FIG. 9, the only variation factor for a design target is the difference in conductive type of the gates in the transistors 123 and 124 except for a matching error between transistors arranged adjacent to each other. That is, the factor of temperature detection variation is extremely limited.

Similarly, in the first voltage generation circuit 110 of FIG. 7, the transistors 114 and 115 are relative circuits. Although the source area differs between the transistors 114 and 115, the transistors 114 and 115 have the same structure except for the difference in the source areas. The transistors 111 to 113 also have the same structure. Further, in the semiconductor substrate, the transistors 114 and 115 are arranged adjacent to each other, and the transistors 111 to 113 are arranged adjacent to each other. In the semiconductor substrate, the resistors 116 and 117 are also arranged adjacent to each other. Then, in the first voltage generation circuit 110 of FIG. 7, the variation factor for a design target is limited to a matching error between transistors arranged adjacent to each other and a matching error between resistors arranged adjacent to each other. That is, the factor of temperature detection variation is extremely limited.

### Numerical Example

Here, a specific numerical example is mentioned. In this numerical example, consider a case where the voltage division ratio in the voltage divider circuit 140 is ⅓ and the target set temperature is 175 degrees C. It is assumed that the temperature coefficient k_{VT} of the voltage V_{T} is “+0.6 [mV/degrees C.]” while the temperature coefficient k_{PN} of the voltage ΔV_{TH} is “−0.6 [mV/degrees C.].” Further, the design value of the voltage V₀ is 1.036 V. Then, when the internal temperature (corresponding to the detection target temperature) of the semiconductor device 1 is 175 degrees C., the voltages ΔV_{TH} and V_{T} are about 900 mV and about 300 mV, respectively.

When the first setting step is not performed, the voltage ΔV_{TH_DIV} varies by ±4 mV around the design value of the voltage ΔV_{TH_DIV} at around 175 degrees C. due to the manufacturing variation. Further, when the second setting step is not performed, the voltage V_{T} varies by ±12 mV around the design value of the voltage V_{T} at around 175 degrees C. due to the manufacturing variation. Then, at around 175 degrees C., a difference between the actual value of the voltage V_{T} and the actual value of the voltage ΔV_{TH_DIV} varies by ±16 mV with respect to a difference between the design value of the voltage V_{T} and the design value of the voltage ΔV_{TH_DIV}. Since a difference between the temperature coefficient of the voltage V_{T} and the temperature coefficient of the voltage ΔV_{TH_DIV} is a difference between “+0.6 [mV/degrees C.]” and “−0.2 [mV/degrees C.],” that is, “0.8 [mV/degrees C.],” the variation of ±16 mV is ±20 degrees C. in terms of temperature from “6÷0.8=20.” That is, in the configuration according to the first example, the temperature detection variation is within about ±20 degrees C. even if the first and second setting steps are not performed.

By performing the first setting step, the variation from the design value of the voltage ΔV_{TH_DIV} can be reduced from ±4 mV to ±2 mV at around 175 degrees C. By performing the second setting step, the variation from the design value of the voltage V_{T} can be reduced from ±12 mV to ±6 mV at around 175 degrees C. Then, by performing the first and second setting steps, the difference between the actual value of the voltage V_{T} and the actual value of the voltage ΔV_{TH_DIV} varies by ±8 mV with respect to the difference between the design value of the voltage V_{T} and the design value of the voltage ΔV_{TH_DIV} at around 175 degrees C. In other words, a difference between the difference of the former and the difference of the latter can be reduced to ±8 mV. The variation of ±8 mV is ±10 degrees C. in terms of temperature. That is, in the configuration according to the first example, when the first and second setting steps are performed, the temperature detection variation can be reduced to about ±10 degrees C.

It is most desirable to perform both the first and second setting steps in order to reduce the temperature detection variation, but it is possible to omit any one of the first and second setting steps and also omit both the first and second setting steps (the same applies to other examples to be described later). If the first setting step is omitted, the resistor 141 may be a fixed resistor. If the second setting step is omitted, the resistor 117 may be a fixed resistor.

### Second Example

A second example of the semiconductor device 1 will be described. In the configuration of the first example of FIG. 6, in order to generate an inversion of the value of the temperature detection signal TSD_{OUT} (the inversion between “0” and “1”) in the vicinity of the operating rated temperature (for example, 150 degrees C. or 175 degrees C.) of the semiconductor device 1, the voltage ΔV_{TH} is divided by the voltage divider circuit 140 to about ⅓, and the voltage ΔV_{TH_DIV} obtained by the voltage division is compared with the voltage V_{T}. Instead of this, the voltage V_{T} may be amplified about three times, and the amplified voltage V_{T} may be compared with the voltage ΔV_{TH}.

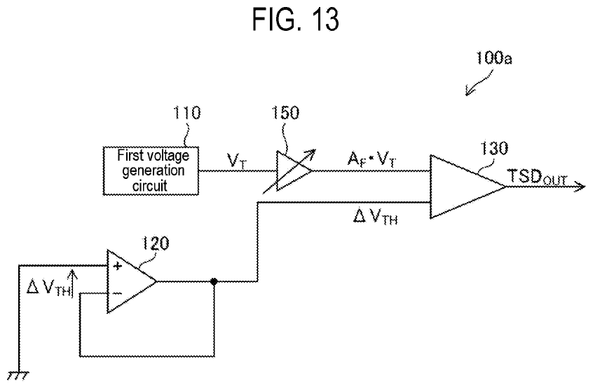

FIG. 13 is a configuration diagram of a temperature detection circuit 100a according to the second example. The temperature detection circuit 100a can be used as the temperature detection circuit 10 of FIG. 1. The temperature detection circuit 100a includes a first voltage generation circuit 110, a second voltage generation circuit 120, a comparator 130, and an amplifier circuit 150. That is, the temperature detection circuit 100a of FIG. 13 is formed by replacing the voltage divider circuit 140 with the amplifier circuit 150 with reference to the temperature detection circuit 100 of FIG. 6. The configuration and operation of the voltage generation circuits 110 and 120 are as shown in the first example.

The amplifier circuit 150 amplifies the voltage V_{T} output from the first voltage generation circuit 110 and outputs the amplified voltage. An amplification factor in the amplifier circuit 150 is referred to by symbol “A_{F}.” Then, an output voltage of the amplifier circuit 150 is represented by “A_{F}·V_{T}” (that is, A_{F} times the voltage V_{T}). The amplification factor A_{F} has a value near 3. Therefore, it is possible to generate the inversion of the value of the temperature detection signal TSD_{OUT} (the inversion between “0” and “1”) in the vicinity of the operating rated temperature (for example, 150 degrees C. or 175 degrees C.) of the semiconductor device 1.

In the temperature detection circuit 100a according to the second example, the voltage ΔV_{TH} output from the second voltage generation circuit 120 and the voltage A_{F}·V_{T} output from the amplifier circuit 150 are input to the comparator 130. Then, in the comparator 130, a value of the temperature detection signal TSD_{OUT} is determined by comparing the voltage ΔV_{TH} and the voltage A_{F}·V_{T}. The comparator 130 outputs the temperature detection signal TSD_{OUT} having a value of “1” when the voltage A_{F}·V_{T} is higher than the voltage ΔV_{TH}, and outputs the temperature detection signal TSD_{OUT} having a value of “0” when the voltage A_{F}·V_{T} is lower than the voltage ΔV_{TH}. As described above, the temperature detection signal TSD_{OUT} having the value of “1” indicates that the detection target temperature is higher than the determination temperature T_{TSD}, and the temperature detection signal TSD_{OUT} having the value of “0” indicates that the detection target temperature is lower than the determination temperature T_{TSD}. When the voltage A_{F}·V_{T} and the voltage ΔV_{TH} match, the comparator 130 outputs the temperature detection signal TSD_{OUT} having the value of “1” or “0.”

Here, the amplifier circuit 150 is configured so that the amplification factor A_{F} is variable. By appropriately adjusting the amplification factor A_{F}, the same operation and effects as in the first example can be obtained. A resistor for determining the amplification factor A_{F} can be provided in the amplifier circuit 150, and the amplification factor A_{F} can be adjusted by adjusting the value of the resistor.

In the second example, the first setting step is modified as follows. The amplifier circuit 150 is configured so that the amplification factor A_{F} can be set to any one of a plurality of candidate amplification factors, and in the first setting step according to the second example, any one of the plurality of candidate amplification factors is selected as the amplification factor A_{F}. The selected first candidate amplification factor is referred to as a set amplification factor. The second setting step is as shown in the first example, and the second set resistance value with respect to the resistor 117 (see FIG. 7) is determined in the second setting step. When the semiconductor device 1 is started after the inspection process including the first and second setting steps, the amplification factor A_{F} has the set amplification factor and the resistor 117 has the second set resistance value.

For example, in the inspection process of the semiconductor device 1, the setting data corresponding to the set amplification factor and the setting data corresponding to the second set resistance value are stored in a non-volatile memory (not shown) provided in the semiconductor device 1. Then, when the semiconductor device 1 is started, the temperature detection circuit 100a reads the setting data corresponding to the set amplification factor and the setting data corresponding to the second set resistance value from the non-volatile memory, so that the amplification factor A_{F} may be set to the set amplification factor and the value of the resistor 117 may be set to the second set resistance value. Alternatively, in the inspection process of the semiconductor device 1, by laser trimming (fuse cut method), the amplification factor A_{F} may be set to the set amplification factor and the value of the resistor 117 may be set to the second set resistance value, and thereafter, the amplification factor A_{F} and the value of the resistor 117 may be unchanged.

In the first setting step according to the second example, the set amplification factor is determined so that the determination temperature T_{TSD} approaches a desired target set temperature as close as possible (possibly matches the desired target set temperature). That is, among the plurality of candidate amplification factors, the candidate amplification factor for minimizing a difference between the determination temperature T_{TSD} and the target set temperature is selected as the set amplification factor.

### Third Example

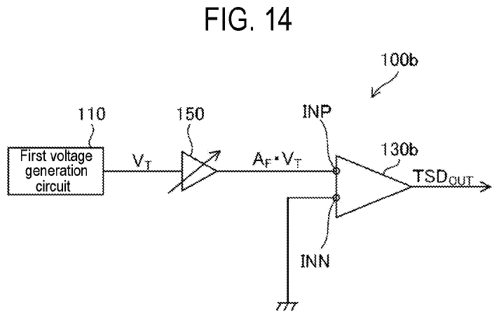

A third example of the semiconductor device 1 will be described. The configuration of FIG. 13 can be modified as shown in FIG. 14, and the same operation and effects as those of the first or second example can be obtained by the configuration of FIG. 14. FIG. 14 is a configuration diagram of a temperature detection circuit 100b according to the third example. The temperature detection circuit 100b can be used as the temperature detection circuit 10 in FIG. 1. The temperature detection circuit 100b includes a first voltage generation circuit 110, a comparator 130b, and an amplifier circuit 150. That is, the temperature detection circuit 100b of FIG. 14 is formed by omitting the second voltage generation circuit 120 and replacing the comparator 130 with the comparator 130b with reference to the temperature detection circuit 100a of FIG. 13.

In the temperature detection circuit 100b, the configuration and operation of the first voltage generation circuit 110 and the setting step (the second setting step) for the variable resistor 117 of the first voltage generation circuit 110 are as shown in the first example. In the temperature detection circuit 100b, the configuration and operation of the amplifier circuit 150 and the setting step (the first setting step according to the second example) for the amplification factor A_{F} of the amplifier circuit 150 are as shown in the second example.

In the temperature detection circuit 100b, instead of omitting the second voltage generation circuit 120, a configuration for obtaining the voltage ΔV_{TH} is included in the comparator 130b. The comparator 130b has input terminals INP and INN and an output terminal. The temperature detection signal TSD_{OUT} is output from the output terminal of the comparator 130b. The voltage A_{F}·V_{T} output from the amplifier circuit 150 is input to the input terminal INP. The input terminal INN is connected to the ground.

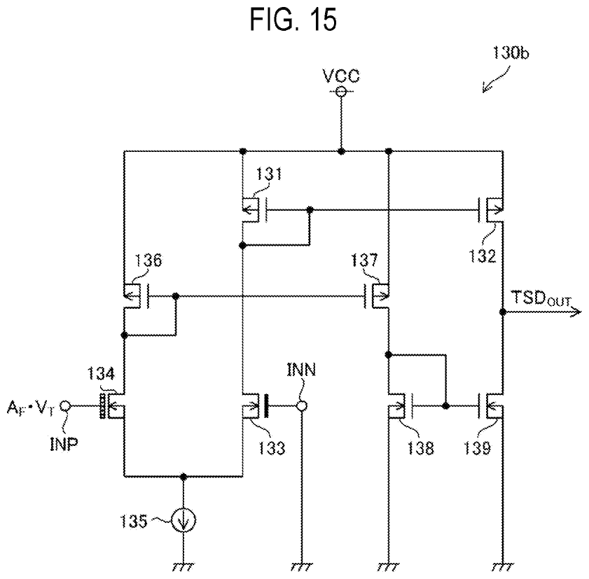

FIG. 15 shows an internal circuit example of the comparator 130b. The comparator 130b of FIG. 15 includes transistors 131 to 134 and 136 to 139 and a constant current source 135. The transistors 131, 132, 136, and 137 are P-channel MOSFETs. The transistors 138 and 139 are N-channel MOSFETs.

The transistors 131 and 132 form a first current mirror circuit. The first current mirror circuit operates so that the drain current of the transistor 131 and the drain current of the transistor 132 have the same current value (however, an error may exist). The transistors 131 and 132 have the same structure and may be arranged adjacent to each other on the semiconductor substrate.

The transistors 136 and 137 form a second current mirror circuit. The second current mirror circuit operates so that the drain current of the transistor 136 and the drain current of the transistor 137 have the same current value (however, an error may exist). The transistors 136 and 137 have the same structure and may be arranged adjacent to each other on the semiconductor substrate.

The transistors 138 and 139 form a third current mirror circuit. The third current mirror circuit operates so that the drain current of the transistor 138 and the drain current of the transistor 139 have the same current value (however, an error may exist). The transistors 138 and 139 have the same structure and may be arranged adjacent to each other on the semiconductor substrate.

The transistor 133 is the same element as the transistor 123 of FIG. 9, and the transistor 134 is the same element as the transistor 124 of FIG. 9. Therefore, the description of the first example for the structures of the transistors 123 and 124 also applies to the transistors 133 and 134, respectively. Since the conductive types of the gates of the transistors 133 and 134 are different from each other, there is a difference between the work function of the gate of the transistor 133 and the work function of the gate of the transistor 134, and by an amount corresponding to the difference, a difference is generated between the gate threshold voltage of the transistor 133 and the gate threshold voltage of the transistor 134. The difference between the gate threshold voltage of the transistor 133 and the gate threshold voltage of the transistor 134 corresponds to the above-mentioned voltage ΔV_{TH}. In the comparator 130b, since a differential input pair is formed by the transistors 133 and 134, the voltage ΔV_{TH} functions as an offset voltage of the comparator 130b. In other words, the voltage ΔV_{TH} is generated as the offset voltage in the differential input pair. As described in the first example, the voltage ΔV_{TH} is about 1.0 V. As a result, the voltage ΔV_{TH} of about 1.0 V is generated as the offset voltage of the comparator 130b.

The connection relationship of the elements of FIG. 15 will be described. Each source of the transistors 131, 132, 136, and 137 is connected to the application end of the internal power supply voltage VCC (that is, the terminal to which the internal power supply voltage VCC is applied). The gate and the drain of the transistor 131, the gate of the transistor 132, and the drain of the transistor 133 are connected in common to each other. The gate of the transistor 133 is connected to the input terminal INN. As described above, the input terminal INN is connected to the ground. The gate and the drain of the transistor 136, the gate of the transistor 137, and the drain of the transistor 134 are connected in common to each other. The gate of the transistor 134 is connected to the input terminal INP. As described above, the output voltage A_{F}·V_{T} of the amplifier circuit 150 is applied to the input terminal INP.

The drain of the transistor 137, the gate and the drain of the transistor 138, and the gate of the transistor 139 are connected in common to each other. Each source of the transistors 138 and 139 is connected to the ground. Each drain of the transistors 132 and 139 is connected to the output terminal of the comparator 130b. Therefore, the temperature detection signal TSD_{OUT} is generated at a connection node between the drains of the transistors 132 and 139.

Each source of the transistors 133 and 134 is connected to one end of the constant current source 135, and the other end of the constant current source 135 is connected to the ground. The constant current source 135 operates so as to flow a predetermined constant current from a node to which the sources of the transistors 133 and 134 are connected, to the ground. The constant current by the constant current source 135 is the sum of the drain current of the transistor 133 and the drain current of the transistor 134.

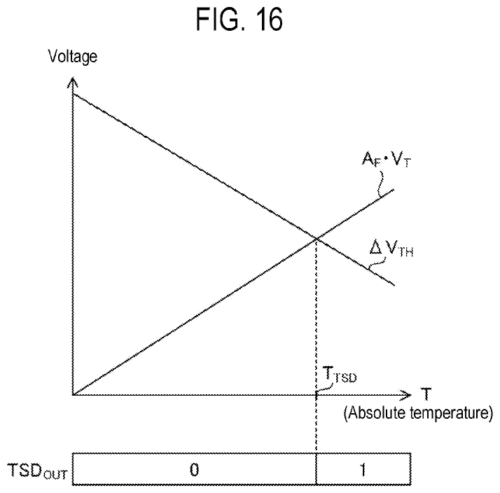

In the comparator 130b of FIG. 15, there is a remarkable difference in the potential of the temperature detection signal TSD_{OUT} when the first inequality “A_{F}·V_{T}>ΔV_{TH}” is established and when the second inequality “A_{F}·V_{T}<ΔV_{TH}” is established, so that the value (logical value) of the temperature detection signal TSD_{OUT} changes. When the first inequality “A_{F}·V_{T}>ΔV_{TH}” is established, the temperature detection signal TSD_{OUT} has a value of “1,” and when the second inequality “A_{F}·V_{T}>ΔV_{TH}” is established, the temperature detection signal TSD_{OUT} has a value of “0” (see FIG. 16). As described above, the temperature detection signal TSD_{OUT} having the value of “1” indicates that the detection target temperature is higher than the determination temperature T_{TSD} and the temperature detection signal TSD_{OUT} having the value of “0” indicates that the detection target temperature is lower than the determination temperature T_{TSD}.

Similar to the transistors 123 and 124 of FIG. 9, the transistors 133 and 134 of FIG. 15 also operate in the sub-threshold region. That is, the gate-source voltage of the transistor 133 is less than the gate threshold voltage of the transistor 133, and a current flows between the drain and the source of the transistor 133 due to sub-threshold conduction. Further, the gate-source voltage of the transistor 134 is less than the gate threshold voltage of the transistor 134, and a current flows between the drain and the source of the transistor 134 due to sub-threshold conduction. By appropriately setting the internal power supply voltage VCC and the gate length, gate width, and the like of each transistor constituting the comparator 130b, the operation in the sub-threshold region can be realized. For example, at the room temperature (25 degrees C.), the constant current from the constant current source 135 is set to about 10 nA (nano ampere).

The magnitude of the constant current by the constant current source 135 may be the same as the magnitude of the current Ia in FIG. 7. That is, for example, the constant current source 135 may be formed in an N-channel MOSFET having a drain connected to each source of the transistors 133 and 134, a gate connected to the gate of the transistor 114 (FIG. 7), and a source connected to the ground.

As described above, the semiconductor device 1 (see FIG. 1) has the semiconductor substrate, and an epitaxial layer is provided on the semiconductor substrate by using epitaxial growth. All MOSFETs (especially, the transistors 133 and 134) included in the first voltage generation circuit 110, the amplifier circuit 150, and the comparator 130b are formed in the epitaxial layer (that is, each MOSFET is formed in the epitaxial layer).

### Fourth Example

A fourth example of the semiconductor device 1 will be described. In the fourth example, some modification items with respect to the above-described configuration and operation will be described.

Various circuits have been proposed as PTAT circuits that generate PTAT voltages with the positive temperature characteristics. Any PTAT circuit that generates and outputs a PTAT voltage may be adopted as the first voltage generation circuit 110. At this time, the PTAT voltage is used as the voltage V_{T}.

Although the transistor 123 (see FIG. 9) is configured by the depletion type MOSFET as an example, the transistor 123 may be configured by an enhancement type MOSFET (the same applies to the transistor 133). At this time, since the transistor 124 has the same structure as the transistor 123 except that the conductive type of the gate is P-type, the transistor 124 is also an enhancement type MOSFET (the same applies to the transistor 134). When the transistor 123 is the enhancement type MOSFET, it is advisable to apply an appropriate positive bias voltage to the gate of the transistor 123 so that the transistor 123 operates in the sub-threshold region (the same applies to the transistor 133). However, when the enhancement type is adopted for the transistor 123, it is necessary to set the internal power supply voltage VCC to be higher than when the depletion type is adopted for the transistor 123. Therefore, when it is desired to keep the internal power supply voltage VCC as low as possible in consideration of power saving and the like, it is preferable to adopt the depletion type transistor 123.

The example in which the temperature detection circuit according to the present disclosure is used for generating the thermal shutdown signal has been described. However, the temperature detection circuit according to the present disclosure can be applied to any application that is required to detect the high/low relationship between the detection target temperature and the predetermined determination temperature.

The type of channel of the FET (Field Effect Transistor) shown in the embodiment is an example, and the configuration of the circuit containing the FET can be modified so that the N-channel type FET is changed to the P-channel type FET or the P-channel type FET is changed to the N-channel type FET.

As long as no inconvenience occurs, any of the above-described transistors may be any kind of transistor. For example, any transistor described above as a MOSFET can be replaced with a junction FET, an IGBT (Insulated Gate Bipolar Transistor) or a bipolar transistor as long as no inconvenience occurs. Any transistor has a first electrode, a second electrode, and a control electrode. In the FET, one of the first and second electrodes is a drain, the other is a source, and the control electrode is a gate. In the IGBT, one of the first and second electrodes is a collector, the other is an emitter, and the control electrode is a gate. In the bipolar transistor that does not belong to the IGBT, one of the first and second electrodes is a collector, the other is an emitter, and the control electrode is a base.

In the present disclosure, the fact that an arbitrary first physical quantity and an arbitrary second physical quantity are “same” is understood as a concept containing an error. That is, the fact that the first physical quantity and the second physical quantity are “same” means that the design or manufacture is performed with the aim of making the first physical quantity and the second physical quantity “same,” and even if there is a slight error between the first and second physical quantities, it should be understood that the first physical quantity and the second physical quantity are “same.” This is not limited to physical quantities (for example, this also applies to an expression that a first structure and a second structure are the same).

### Supplementary Notes

Supplementary Notes are provided regarding the temperature detection circuit according to the present disclosure.

A temperature detection circuit (10, 100, 100a) according to one aspect of the present disclosure is a configuration (first configuration) including a first voltage generation circuit (110) configured to generate a first voltage (V_{T}) having a positive temperature characteristic, a second voltage generation circuit (120) that includes a first MOSFET (123) having a gate of a first conductive type and a second MOSFET (124) having a gate of a second conductive type different from the first conductive type, and configured to generate a second voltage ONTO having a negative temperature characteristic based on a difference in gate threshold voltages between the first MOSFET and the second MOSFET, and a comparator (130) configured to output a temperature detection signal indicating a high/low relationship between a detection target temperature and a predetermined temperature (T_{TSD}), based on the first voltage and the second voltage.

The temperature detection circuit of the first configuration may be a configuration (second configuration) further including a voltage divider circuit configured to divide the second voltage with a variable voltage division ratio, wherein the comparator is configured to output the temperature detection signal by comparing the first voltage and the divided second voltage.

The temperature detection circuit of the first configuration may be a configuration (third configuration) further including an amplifier circuit configured to amplify the first voltage with a variable amplification factor, wherein the comparator is configured to output the temperature detection signal by comparing the amplified first voltage and the second voltage.

The temperature detection circuit of any one of the first to third configurations may be a configuration (fourth configuration) wherein in the second voltage generation circuit, sources of the first MOSFET and the second MOSFET are connected in common, and when a current having the same magnitude is supplied to the first MOSFET and the second MOSFET, a difference between a gate potential of the first MOSFET and a gate potential of the second MOSFET is generated as the second voltage.

The temperature detection circuit of any one of the first to fourth configurations may be a configuration (fifth configuration) wherein the first voltage generation circuit is configured to generate the first voltage by using two MOSFETs operating at different current densities.

The temperature detection circuit of the fifth configuration may be a configuration (sixth configuration) wherein the first voltage generation circuit is configured to be capable of adjusting a temperature coefficient of the first voltage by using a variable resistor.

The temperature detection circuit of the fifth or sixth configuration may be a configuration (seventh configuration) wherein the two MOSFETs operate in a sub-threshold region.

The temperature detection circuit of any one of the first to seventh configurations may be a configuration (eighth configuration) wherein the first MOSFET and the second MOSFET operate in a sub-threshold region.

A temperature detection circuit (100b) according to another aspect of the present disclosure is a configuration (ninth configuration) including a voltage generation circuit (110) configured to generate a positive temperature characteristic voltage (V_{T}) having a positive temperature characteristic, and a comparator (130) configured to output a temperature detection signal indicating a high/low relationship between a detection target temperature and a predetermined temperature (T_{TSD}), based on the positive temperature characteristic voltage, wherein the comparator includes a first MOSFET (133) having a gate of a first conductive type and a second MOSFET (134) having a gate of a second conductive type different from the first conductive type, as a differential input pair, and wherein a voltage based on the positive temperature characteristic voltage is input between the gate of the first MOSFET and the gate of the second MOSFET.

The temperature detection circuit of the ninth configuration may be a configuration (tenth configuration) wherein an offset voltage having a negative temperature characteristic is generated in the differential input pair based on a difference in gate threshold voltages between the first MOSFET and the second MOSFET, and the temperature detection signal is generated in the comparator based on the offset voltage and the voltage based on the positive temperature characteristic voltage.

The temperature detection circuit of the ninth or tenth configuration may be a configuration (eleventh configuration) further including an amplifier circuit configured to amplify the positive temperature characteristic voltage with a variable amplification factor, wherein the amplified positive temperature characteristic voltage is input between the gate of the first MOSFET and the gate of the second MOSFET.

The temperature detection circuit of any one of the ninth to eleventh configurations may be a configuration (twelfth configuration) wherein the voltage generation circuit is configured to generate the positive temperature characteristic voltage by using two MOSFETs operating at different current densities.

The temperature detection circuit of the twelfth configuration may be a configuration (thirteenth configuration) wherein the voltage generation circuit is configured to be capable of adjusting a temperature coefficient of the positive temperature characteristic voltage by using a variable resistor.

The temperature detection circuit of the twelfth or thirteenth configuration may be a configuration (fourteenth configuration) wherein the two MOSFETs operate in a sub-threshold region.

The temperature detection circuit of any one of the ninth to fourteenth configurations may be a configuration (fifteenth configuration) wherein the first MOSFET and the second MOSFET operate in a sub-threshold region.

The temperature detection circuit of any one of the first to fifteenth configurations may be a configuration (sixteenth configuration) wherein the first MOSFET and the second MOSFET are formed at an epitaxial layer provided on a semiconductor substrate.

A semiconductor device according to the present disclosure is a configuration (seventeenth configuration) including the temperature detection circuit of any one of the first to sixteenth configurations, and a functional circuit capable of executing a predetermined operation, wherein the functional circuit is configured to stop the predetermined operation in response to an output of the temperature detection signal indicating that the detection target temperature is higher than the predetermined temperature.

The embodiments of the present disclosure can be appropriately modified in various ways within the scope of the technical idea shown in the claims. The above embodiments are merely examples, and the meanings of the terms of the present disclosure or constituent requirements are not limited to those described in the above embodiments. The specific numerical values shown in the above description are merely examples, and as a matter of course, they can be changed to other various numerical values.

According to the present disclosure in some embodiments, it is possible to provide a temperature detection circuit that contributes to improving the accuracy of temperature detection, and a semiconductor device including the same.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A temperature detection circuit comprising:
a first voltage generation circuit configured to generate a first voltage having a positive temperature characteristic;
a second voltage generation circuit that includes a first MOSFET having a gate of a first conductive type and a second MOSFET having a gate of a second conductive type different from the first conductive type, and configured to generate a second voltage having a negative temperature characteristic based on a difference in gate threshold voltages between the first MOSFET and the second MOSFET; and
a comparator configured to output a temperature detection signal indicating a high/low relationship between a detection target temperature and a predetermined temperature, based on the first voltage and the second voltage.

2. The temperature detection circuit of claim 1, further comprising: a voltage divider circuit configured to divide the second voltage with a variable voltage division ratio,
wherein the comparator is configured to output the temperature detection signal by comparing the first voltage and the divided second voltage.

3. The temperature detection circuit of claim 1, further comprising: an amplifier circuit configured to amplify the first voltage with a variable amplification factor,
wherein the comparator is configured to output the temperature detection signal by comparing the amplified first voltage and the second voltage.

4. The temperature detection circuit of claim 1, wherein in the second voltage generation circuit, sources of the first MOSFET and the second MOSFET are connected in common, and when a current having the same magnitude is supplied to the first MOSFET and the second MOSFET, a difference between a gate potential of the first MOSFET and a gate potential of the second MOSFET is generated as the second voltage.

5. The temperature detection circuit of claim 1, wherein the first voltage generation circuit is configured to generate the first voltage by using two MOSFETs operating at different current densities.

6. The temperature detection circuit of claim 5, wherein the first voltage generation circuit is configured to be capable of adjusting a temperature coefficient of the first voltage by using a variable resistor.

7. The temperature detection circuit of claim 5, wherein the two MOSFETs operate in a sub-threshold region.

8. The temperature detection circuit of claim 1, wherein the first MOSFET and the second MOSFET operate in a sub-threshold region.

9. A temperature detection circuit comprising:
a voltage generation circuit configured to generate a positive temperature characteristic voltage having a positive temperature characteristic; and
a comparator configured to output a temperature detection signal indicating a high/low relationship between a detection target temperature and a predetermined temperature, based on the positive temperature characteristic voltage,
wherein the comparator includes a first MOSFET having a gate of a first conductive type and a second MOSFET having a gate of a second conductive type different from the first conductive type, as a differential input pair, and
wherein a voltage based on the positive temperature characteristic voltage is input between the gate of the first MOSFET and the gate of the second MOSFET.

10. The temperature detection circuit of claim 9, wherein an offset voltage having a negative temperature characteristic is generated in the differential input pair based on a difference in gate threshold voltages between the first MOSFET and the second MOSFET, and
wherein the temperature detection signal is generated in the comparator based on the offset voltage and the voltage based on the positive temperature characteristic voltage.

11. The temperature detection circuit of claim 9, further comprising: an amplifier circuit configured to amplify the positive temperature characteristic voltage with a variable amplification factor,
wherein the amplified positive temperature characteristic voltage is input between the gate of the first MOSFET and the gate of the second MOSFET.

12. The temperature detection circuit of claim 9, wherein the voltage generation circuit is configured to generate the positive temperature characteristic voltage by using two MOSFETs operating at different current densities.

13. The temperature detection circuit of claim 12, wherein the voltage generation circuit is configured to be capable of adjusting a temperature coefficient of the positive temperature characteristic voltage by using a variable resistor.

14. The temperature detection circuit of claim 12, wherein the two MOSFETs operate in a sub-threshold region.

15. The temperature detection circuit of claim 9, wherein the first MOSFET and the second MOSFET operate in a sub-threshold region.

16. The temperature detection circuit of claim 1, wherein the first MOSFET and the second MOSFET are formed at an epitaxial layer provided on a semiconductor substrate.

17. A semiconductor device comprising:
the temperature detection circuit of claim 1; and
a functional circuit capable of executing a predetermined operation,
wherein the functional circuit is configured to stop the predetermined operation in response to an output of the temperature detection signal indicating that the detection target temperature is higher than the predetermined temperature.
